(19) United States
(12) Patent Application Publication
(10) Pub. No.: US 2008/0225224 A1
(43) Pub. Date: Sep. 18, 2008

(54) ADHESIVE-FILM EXFOLIATING DEVICE AND MANUFACTURING METHOD OF LIQUID CRYSTAL DISPLAY PANEL USING THE DEVICE

(75) Inventors: Takeshi TOYOSHIMA, Yokohama-shi (JP); Tanemasa HARADA, Tokyo (JP); Shigeru IWASE, Chigasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/048,606

(22) Filed: Mar. 14, 2008

(30) Foreign Application Priority Data
Mar. 16, 2007 (JP) 2007-068920

(51) Int. Cl. G02F 1/1333; B32B 38/10

(52) U.S. Cl. 349/187; 156/584

(57) ABSTRACT

An adhesive-film exfoliating device includes first and second guide tables 5, 6 having flat mount surfaces 5a, 6a for mounting a liquid crystal display panel 2 having glass plates 3 and polarizing plates 4, a take-up roller 7 on the backside of the tables 5, 6 and a slit 8 arranged between the guide tables 5, 6 to allow a passage of one polarizing plate 4 exfoliated from the lower glass plate 3. The slit 8 is formed with a breadth less than 5 mm. The breadth corresponds to a dimension of the slit 8 in a feeding direction of the glass plate 3 on the flat mount surfaces 5a, 6a. In a manufacturing method of the liquid crystal display panel 2, a process of exfoliating one polarizing plate 4 from the lower glass plate 3 includes a step of pulling the polarizing plate 4 through the slit 8 in a direction to exfoliate the plate 4 from the glass plate 3.

### BACKGROUND OF THE INVENTION

1. Field of the Invention

The present invention relates to an adhesive-film exfoliating device for exfoliating an adhesive film and a manufacturing method of a liquid crystal display panel using the adhesive-film exfoliating device. More particularly, the invention relates to an adhesive-film exfoliating device used in exfoliating an adhesive film, such as polarizing plate, from a glass plate of a liquid crystal display panel and a manufacturing method of the liquid crystal display panel, the method including a process of exfoliating the adhesive film from the glass plate by using the adhesive-film exfoliating device.

2. Description of the Related Art

Generally, the liquid crystal display panel comprises a pair of laminated glass plates interposing liquid crystal therebetween and polarizing plates adhered to external surfaces of the glass plates.

If a polarizing plate has a defective, such as scratches or impurity, found at an appearance inspection or lighting test for the liquid crystal display panel, it is necessary to exfoliate the defective polarizing plate from the glass plate and replace the former plate with a new non-defective polarizing plate.

Japanese Patent Publication Laid-open No. 2006-299064 discloses an adhesive-film exfoliating device which is used to exfoliate a polarizing plate from the glass plate.

The above adhesive-film exfoliating device is illustrates in FIGS. 1 and 2 partially. As shown in FIG. 1, the adhesive-film exfoliating device includes a plurality of carrier rollers 100, a pair of guide rollers 101 and a take-up roller 102. These rollers 100, 101 and 102 are arranged so that respective rotational center lines are paralleled with each other. The guide rollers 101 in pairs are adjacent to each other. The take-up roller 102 is operationally connected to a drive motor (not shown) as drive means, while no drive means is associated with the carrier rollers 100 or the guide rollers 101.

When required to exfoliate a polarizing plate 105 sticking to the glass plate 104, the polarizing plate 105 is partially exfoliated from the glass plate 104 at one corner of a liquid crystal display panel 103 and successively, it is mounted on the carrier roller 102 on making the so-exfoliated polarizing plate 105 direct downwardly.

Next, preparing an adhesive tape (not shown), its one end is applied to the exfoliated corner of the polarizing plate 105. While, the other end of the adhesive tape is led toward the take-up roller 102 through a gap between the guide rollers 101 and finally applied on the take-up roller 12.

Subsequently, the drive motor is driven to rotate the take-up roller 102 in the direction of arrow “A”. With the rotation of the take-up roller 102 in the direction of arrow “A”, the polarizing plate 105 is exfoliated from the glass plate 104 in the pulling direction of arrow “B”. The polarizing plate 105 off the glass plate 104 is taken up by the take-up roll 102. While the polarizing plate 105 is pulled in the direction of arrow “B” and exfoliated from the glass plate 104, the liquid crystal display panel 103 moves on the carrier roller 100 in the direction of arrow “C”.

### SUMMARY OF THE INVENTION

However, the above-mentioned adhesive-film exfoliating device is not thoughtful of the following points.

First, when the polarizing plate 105 is pulled in the direction of arrow “B” and exfoliated from the glass plate 104, the liquid crystal display panel 103 makes contact with the guide rollers 101 at two contact points “D”, “D”. An interval “E” between the contact points “D”, “D” is substantially equal to the diameter of each guide roller 101. The diameter of the guide roller 101 has to be reduced in order to make the interval “E” smaller. However, there is a limit to reduce the diameter of the guide roller 101 while maintaining the strength of the guide roller 101.

When the polarizing plate 105 is pulled in the direction of arrow “B” on condition that the liquid crystal display panel 103 is making contact with the guide rollers 101 at two contact points “D”, “D”, a convex deflection in the direction of arrow “B” (i.e. a recess area on the front side) is produced in a part of the liquid crystal display panel 103 between the contacts “D”, “D”, so that a bending stress in the direction of arrow “B” with the contact points “D”, “D” as fulcrums is applied on the liquid crystal display panel 103. The bending stress has a tendency of increasing as the interval “E” between the contact points “D”, “D” gets increased. If the bending stress on the liquid crystal display panel 103 exceeds a certain value, then the glass plate 101 collapses. Recently, with progress in thin formation of the liquid crystal display panel 103, the glass plate 104 in the panel 103 is also reduced in its thickness. In the so-thinned liquid crystal display panel 103, the thickness of the glass plate 104 is reduced to approx. 0.2 mm recently. Under this situation, the glass plate 104 is easy to be broken in pulling the polarizing plate 105 to exfoliate it from the glass plate 104.

Under such a situation, an object of the present invention is to provide an adhesive-film exfoliating device capable of suppressing bending stress acting on an adhered object when pulling an adhesive film in order to exfoliate it from the adhered object to thereby prevent it from being broken by an excessive bending stress. Another object of the present invention is to provide a manufacturing method of a liquid crystal display panel, having a process of exfoliating the adhesive film from the adhered object while suppressing a bending stress exerted on it.

In order to attain the former object, according to the present invention, there is provided an adhesive-film exfoliating device comprising: a guide configured to guide an adhered object having an adhesive film adhered thereto in transportation, the guide having a flat mount surface formed to mount the adhered object thereon; an exfoliator configured to exfoliate the adhesive film from the adhered object, the exfoliator being arranged on the backside of a surface of the guide including the flat mount surface and constructed so as to pull the adhesive film in a direction to exfoliate the adhesive film from the adhered object; and a slit formed in the guide so as to segmentalise the flat mount surface thereby allowing a passage of the adhesive film exfoliated from the adhered object by the exfoliator.

In order to attain the latter object, according to the present invention, there is also provided a manufacturing method of a liquid crystal display panel, comprising, in a process of exfoliating an adhesive film, which is a polarizing plate, adhered to a main surface of the liquid crystal display panel, the steps of: exfoliating a part of the adhesive film from the main surface of the liquid crystal display panel; mounting the main surface of the liquid crystal display panel where the part of the adhesive film has been exfoliated, on a flat mount surface of a guide provided with a slit; pulling the adhesive film through the slit thereby exfoliating the adhesive film from the main surface of the liquid crystal display panel.

With the above adhesive-film exfoliating device and the above manufacturing method of a liquid crystal display panel, when the exfoliator pulls the adhesive film in order to exfoliate it from the adhered object, a bending stress applied on the adhered object can be moderated to prevent it from being broken by an excessive bending stress.

### BRIEF DESCRIPTION OF THE DRAWINGS

FIG. 1 is a side view of an adhesive-film exfoliating device in prior art;

FIG. 2 is a side view of a part of the device of FIG. 1 in enlargement;

FIG. 3 is a perspective view showing an adhesive-film exfoliating device in accordance with an embodiment of the present invention;

FIG. 4 is a side view of the adhesive-film exfoliating device of FIG. 3; and

FIG. 5 is a typical view explaining a force applied on a liquid crystal display panel when a polarizing plate is pulled to exfoliate a glass plate therefrom.

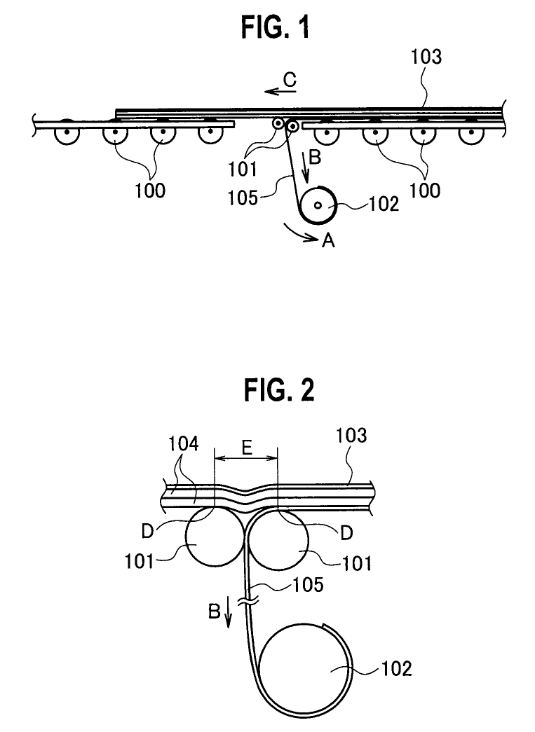

### DETAILED DESCRIPTION OF THE PREFERRED EMBODIMENTS

An embodiment of the present invention will be described with reference to attached drawings.

An adhesive-film exfoliating device 1 of this embodiment is adapted so as to exfoliate a polarizing plate 4 (as an adhesive film) from a glass plate 3 (as an adhered object) forming a liquid crystal display panel 2. The exfoliating device 1 is provided with a guide (as guiding means) for guiding the liquid crystal display panel 2 in transportation. The guide includes, in a feeding direction of the liquid crystal display panel 2, a first guide table 5 (as a first guide member) on the upstream side of the feeding direction and a second guide table 6 (as a second guide member) on the downstream side. The first and the second guide tables 5, 6 have respective flat mount surfaces 5a, 6a formed to mount the liquid crystal display panel 2 thereon, respectively. The flat mount surface 5a is substantially level with the flat mount surface 6a. On the backside of the first and the second guide tables 5, 6 (i.e. an opposite side of the mount surfaces 5a, 6a), there is a take-up roller 7 (as an exfoliator) which pulls the polarizing plate 4 in a direction to exfoliate it from the glass plate 3. A slit 8 is formed between the first guide table 5 and the second guide table 6. In other words, through the slit 8, the guide is segmentalised to the first guide table 5 on the upstream side in the feeding direction and the second guide table 6 on the downstream side. Through the slit 8, the polarizing plate 4 exfoliated from the glass plate 3 is led to the take-up roller 7.

The liquid crystal display panel 2 comprises two sheets of glass plates 3 in lamination, liquid crystal enclosed between the glass plates 3 in lamination and a pair of polarizing plates 4 adhered to both outside surfaces of the glass plates 3. In operation, the liquid crystal display panel 2 is mounted on the first and the second guide tables 5, 6 so that a panel's surface adhering to the polarizing plate 4 to be exfoliated makes contact with the mount surfaces 5a, 6a.

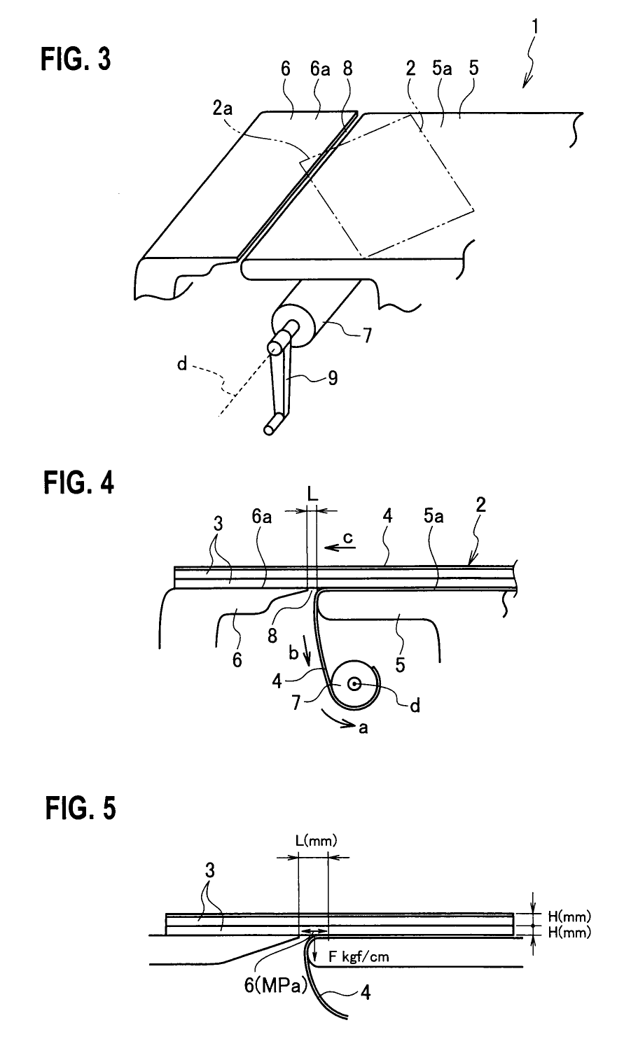

On the mount surfaces 5a, 6a of the first and the second guide tables 5, 6, the liquid crystal display panel 2 is arranged in a manner that one corner 2a intersects with the slit 8 in advance of other parts of the panel 2, as shown with a two-dot chain line of FIG. 3.

In mounting the liquid crystal display panel 2 on the mount surfaces 5a, 6a, the polarizing plate 4 is exfoliated from the liquid crystal display panel 2 at the corner 2a intersecting with the slit 8 and successively, one end of an adhesive tape (not shown) is adhered to the so-exfoliated corner 2a. The other end of the adhesive tape is led toward the take-up roller 7 through the slit 8 and finally adhered to the same roller 7.

The take-up roller 7 is rotatably supported around a center line d and arranged so that the center line is parallel with the slit 8. A handle 9 is connected to one end of the take-up roller 7. The take-up roller 7 is rotated about the center line “d” by rotating the handle 9. With the rotation of the handle 9, the rotating of the take-up roller 7 in the direction of arrow “a” causes the polarizing plate 4 to be pulled in the direction of arrow “b” and exfoliated from the glass plate 3. The so-exfoliated polarizing plate 4 is taken up by the take-up roller 7. With the exfoliation of the polarizing plate 4 from the glass plate 3 as a result of being pulled in the direction of arrow “b”, the liquid crystal display panel 2 moves on the mount surfaces 5a, 6a of the first and the second guide tables 5, 6 in the direction of arrow “c”.

During moving of the liquid crystal display panel 2 in the direction of arrow “c” due to the exfoliation of the polarizing plate 4, the first guide table 5 comes into contact with the polarizing plate 4 adhered to the glass plate 3 and is made of metal, such as stainless steel. The mount surface 5a of the first guide table 5 is finished like a mirror.

During the moving of the liquid crystal display panel 2 in the direction of arrow “c”, the second guide table 6 comes into contact with the glass plate 3 after the polarizing plate 4 has been exfoliated and is made of conductive resin softer than the glass plate 3, for example, polyamide 6 (Product Name: MC nylon).

Through the slit 8, the polarizing plate 4 exfoliated from the liquid crystal display panel 2 is taken up by the take-up roller 7. The slit 8 has a width L less than 5 mm, preferably, less than 3 mm.

The first guide table 5 and the second guide table 6 are respectively connected to ground through the intermediary of not-shown conductive members (e.g. copper foils). The conductive members to ground are attached to the first and the second guide tables 5, 6 in the vicinity of their parts in friction with the liquid crystal display panel 2, respectively.

After the polarizing plate 4 has been exfoliated from the glass plate 3, a new polarizing plate is adhered to the glass plate 3, so that the liquid crystal display panel 1 can be reproduced.

In the constitution mentioned above, the polarizing plate 4 is exfoliated from the glass plate 3 while beginning at a corner 2a of the liquid crystal display panel 2. Then, as shown in FIG. 3, the liquid crystal display panel 2 is arranged on the mount surfaces 5a, 6a of the first and the second guide tables 5, 6 so that the corner 2a firstly intersects with the slit 8 in advance of the other parts of the panel 2. Previous to this arrangement of the liquid crystal display panel 2, an adhesive tape (not shown) is prepared and continuously, one end of the tape is adhered to a corner of the polarizing plate 4 exfoliated from the glass plate 3, while the other end of the tape is led through the slit 8 and applied onto the take-up roller 7.

After applying the other end of the adhesive tape to the take-up roller 7, the handle 9 is operated to rotate the take-up roller 7 in the direction of arrow “a”. Consequently, the polarizing plate 4 is pulled off the glass plate 3 in the direction of arrow “b” and taken up by the take-up roller 7.

In pulling the polarizing plate 4 with the rotation of the take-up roller 7, the liquid crystal display panel 2 is pressed against one edge of the first guide table 5 on the side of the slit 8 and one edge of the second guide table 6 on the same side. That is, a downward force directing the take-up roller 7 is applied on the liquid crystal display panel 2.

We now describe the downward force with reference to FIG. 5, in detail.

Assume, H (mm) represents a plate thickness of the glass plate 3, L (mm) a breadth of the slit (i.e. dimension in the feeding direction of the panel 2), F (kgf/cm) an adhesive force of the polarizing plate 4 to the glass plate 3 and σ (Mpa) represents a maximum bending stress acting on the liquid crystal display panel 2.

In FIG. 5, the bending stress cr on the liquid crystal display panel 2 is expressed as

σ=3FL/4H². (1)

Suppose, the glass plate has a strength X (Mpa). Then, the breaking condition of the glass plate 3 is as

σ≧X. (2)

That is, if the following conditions are satisfied, the glass plate 3 is broken:

X≦3FL/4H², (3)

L≧4XH/3F². (4)

Thus, substituting 100 Mpa as the strength X of a glass plate 3 used in the recent liquid crystal display panel 2, 0.2 mm as the plate thickness H of the glass plate 3 in the recent panel 2 and 1.0 kgf/cm as the adhesive force of the polarizing plate 4 in the recent panel 2 to the glass plate 3 into the expression (4), the calculation result is as L≧5.3 (mm).

That is, in the liquid crystal display panel 2 of the recent use, with the adoption of a slit 8 having a breadth L less than 5 mm, it is possible to prevent the glass plate 3 from being broken in exfoliating the polarizing plate 4 from the glass plate 3 with use of the exfoliating device 1.

Regarding the movement of the liquid crystal display panel 2 in the direction of arrow “c” (see FIG. 4) accompanied with the exfoliation of the polarizing plate 4 from the glass plate 3, it should be noted that static electricity is produced since the glass plate 3 is in friction with the first and the second guide tables 5, 6.

The resultant static electricity (electrical charge) is transferred to the first and the second guide tables 5, 6 and subsequently discharged from the tables 5, 6 to ground through earth members. In this way, it is possible to prevent the liquid crystal display panel 2 from taking an electrical charge and also possible to prevent circuits inside the panel 2 from being damaged by the static electricity.

The first guide table 5 is made of electrically conductive metal. In operation, the mount surface 5a of the first guide table 5 comes into contact with the polarizing plate 4 adhered to the lower glass plate 3. This polarizing plate 4 is exfoliated from the glass plate 3 and subsequently discarded later on. For this reason, the first guide table 5 may be made of relatively hard metal. Even if the first guide table 5 is in friction with the polarizing plate 4, a problem of damaging the glass plate 3 is not produced al all.

The second guide table 6 is made of electrically conductive resin having a lower hardness than the glass plate 3. In operation, the mount surface 6a of the second guide table 6 comes into contact with a part of the lower glass plate 3 where the polarizing plate 4 has been exfoliated. Therefore, with the adoption of resinous material softer than the glass plate 3, it is possible to prevent the glass plate 3 from getting scratched despite that the second guide table 6 is in friction with the glass plate 3, causing no problem of scratching a reusable portion of the liquid crystal display panel 2.

In this way, according to the present invention, it is possible to suppress a bending stress on the adhered object in pulling the adhesive film in the process of exfoliating it from the adhered object, whereby the breakage of the adhered object by an excessive bending stress can be prevented.

Although the present invention has been described above by reference to one embodiment of the invention, this invention is not limited to this and modifications will occur to those skilled in the art, in light of the teachings. The scope of the invention is defined with reference to the following claims.

This application is based upon the Japanese Patent Applications No. 2007-068920, filed on Mar. 16, 2007, the entire content of which is incorporated by reference herein.

What is claimed is:

1. An adhesive-film exfoliating device comprising:
a guide configured to guide an adhered object having an adhesive film adhered thereto in transportation, the guide having a flat mount surface formed to mount the adhered object thereon;
an exfoliator configured to exfoliate the adhesive film from the adhered object, the exfoliator being arranged on the backside of a surface of the guide including the flat mount surface and constructed so as to pull the adhesive film in a direction to exfoliate the adhesive film from the adhered object; and
a slit formed in the guide so as to segmentalise the flat mount surface thereby allowing a passage of the adhesive film exfoliated from the adhered object by the exfoliator.

2. The adhesive-film exfoliating device of claim 1, wherein
the slit is formed with a breadth less than 5 mm, the breadth being a dimension of the slit in a feeding direction of the adhered object on the flat mount surface.

3. The adhesive-film exfoliating device of claim 2, wherein
the guide is made of electrically conductive material.

4. The adhesive-film exfoliating device of claim 3, wherein
the guide comprises a first guide member arranged on the upstream side of the slit in the feeding direction and a second guide member arranged on the downstream side of the slit in the feeding direction;
the first guide member is made of metal; and
the second guide member is made of conductive resin.

5. The adhesive-film exfoliating device of claim 1, wherein
the guiding is connected to ground.

6. The adhesive-film exfoliating device of claim 1, wherein
the adhesive film is a polarizing plate, while the adhered object is a glass plate forming a liquid crystal display panel.

7. A manufacturing method of a liquid crystal display panel, comprising, in a process of exfoliating an adhesive film, which is a polarizing plate, adhered to a main surface of the liquid crystal display panel, the steps of:
exfoliating a part of the adhesive film from the main surface of the liquid crystal display panel;
mounting the main surface of the liquid crystal display panel where the part of the adhesive film has been exfoliated, on a flat mount surface of a guide provided with a slit;
pulling the adhesive film through the slit thereby exfoliating the adhesive film from the main surface of the liquid crystal display panel.

8. The manufacturing method of claim 7, wherein
the slit is formed with a breadth less than 5 mm, the breadth being a dimension of the slit in a feeding direction of the main surface of the liquid crystal display panel on the flat mount surface.
